(19) United States
(12) Patent Application Publication
(10) Pub. No.: US 2010/0117933 A1
(43) Pub. Date: May 13, 2010

(54) HIGH RESOLUTION COMPUTER OPERATED DIGITAL DISPLAY SYSTEM

(76) Inventor: David Gothard, Naples, FL (US)

Correspondence Address: GOODMAN, ALLEN & FILETTI PLLC, 4501 HIGHWOODS PARKWAY, SUITE 210, GLEN ALLEN, VA, 23060, US

(21) Appl. No.: 12/690,699

(22) Filed: Jan. 20, 2010

Related U.S. Application Data
(63) Continuation of application No. 11/707,523, filed on Feb. 15, 2007, now abandoned.
Application No. 11/707,523 is a continuation of application No. 10/447,728, filed on May 28, 2003, now abandoned.
Application No. 11/707,523 is a continuation-in-part of application No. 10/010,556, filed on Nov. 8, 2001, now abandoned.
Application No. 10/010,556 is a continuation-in-part of application No. 09/500,284, filed on Feb. 8, 2000, now Pat. No. 6,215,411.
Application No. 09/500,284 is a continuation-in-part of application No. 09/295,894, filed on Apr. 21, 1999, now Pat. No. 6,384,736.
Application No. 09/295,894 is a continuation of application No. 09/132,456, filed on Aug. 11, 1998, now abandoned.
(60) Provisional application No. 60/384,221, filed on May 29, 2002.
(60) Provisional application No. 60/083,597, filed on Apr. 30, 1998.

(51) Int. Cl. G09G 3/28; G06F 15/16

(52) U.S. Cl. 345/55; 345/60; 709/217

(57) ABSTRACT

A high definition and high resolution digital display system, which is computer operated and preferably in the form of a plasma operated display system. More preferably the display system may adopt the form of a television system. The computer controls the generation of the display on the display screen with X-Y coordinate signals such that the computer provides for generation of the display on the plasma screen. The display system may have those features which allow for a high resolution display system with high definition, if desired.

### CROSS REFERENCE TO RELATED APPLICATIONS

This application is a continuation of application Ser. No. 11/707,523, filed Feb. 15, 2007, which is a continuation of application Ser. No. 10/447,728, filed May 28, 2003, now abandoned), which claims priority from Provisional Application 60/384,221, filed May 29, 2002, and which is a continuation-in-part of application Ser. No. 10/010,556, filed Nov. 8, 2001, (now abandoned), which is a continuation-in-part of application Ser. No. 09/500,284, filed Feb. 8, 2000, (issued as U.S. Pat. No. 6,215,411 B1, on Apr. 10, 2001), which is a continuation-in-part of application Ser. No. 09/295,894, filed Apr. 21, 1999, (issued as U.S. Pat. No. 6,384,736 B1, on May 7, 2002), which is a continuation of application Ser. No. 09/132,456, filed Aug. 11, 1998, (now abandoned), which claims priority from U.S. Provisional Application No. 60/083,597, filed Apr. 30, 1998.

### BACKGROUND

This invention relates in general to certain new and useful improvements in high resolution display systems primarily based on relatively flat high resolution display panels and particularly gas plasma operated display panels. More particularly, the invention relates to a display system of the type stated which allows for presentation of either static or continuous images broadcast from a remote source or otherwise delivered from a remote source by hardwire communication.

Until recently, the art of broadcasting video displays primarily relied upon a raster pattern display screen with a plurality of guns located rearwardly of the screen projecting beams to the front of the screen. This type of display was used effectively and is still used effectively in radar systems and television sets and the like. More recently, there have been several improvements in display screens which rely upon light emitting diodes such as LCD, display screens as well as other types of displays.

In essentially all cases, the display screen was somewhat fragile, relatively heavy in view of a power generator which had to be included therein and even more so was quite bulky. The dimension from the front of the display screen to the rear portion thereof was usually fairly substantial. Consequently, there had long been a desire for a relatively flat panel display screen.

In the relatively recent past, that flat panel screen was actually made available by the development of a plasma operated screen. However, and heretofore, that screen which was largely experimental when it was originally developed, and never found its way into any type of display system, such as a television system, until very recently. Notwithstanding, the applicant at the very early stage of development of the plasma operated screen recognized a potential and a way to use that screen in a digitally operated display system. The applicant realized the possibilities of using a plasma display screen with a dedicated computer, such that the plasma operated screen was controlled through the computer. In other words, the computer controls the X-Y display on the screen.

One of the problems with the plasma operated screen is that they initially suffered from a large number of disadvantages, including the fact that they were quite fragile. Consequently, the screen had to be protected, usually by a transparent cover sheet in the front of the screen. Moreover, great care had to be taken when using the screen in any type of display. Otherwise, the screen would crack and would be rendered useless as a medium for a display. In addition, the plasma operated screens were not only subject to breakage, but they were quite costly.

One of the significant problems which arose in connection with the use of the plasma screens and, in fact, still does exist in connection with the use of plasma screens, is the fact that they generate a substantial amount of heat. Moreover, because the computer is located in close proximity to the screen, the two exist in alien operating conditions. The screen generates a substantial amount of heat and the computer cannot operate efficiently in a substantial amount of heat. Consequently, a cooling system also had to be used and presently still has to be used in connection with the use of a plasma operated display screen.

Display screens are presently used in a variety of environments and in a variety of environmental conditions. In some cases, retail store operations will use a television type display in the front of the store as an attraction to potential customers and as an attempt to invite potential customers. Depending on the location of that store, in a relatively cold region, the display system could be subjected to relatively low temperatures. In contrast, if the display system is used in a relatively hot area, the screen would be subjected to relatively high temperatures. Consequently, there was a need to provide a standard, relatively uniform operating temperature devoid of wide temperature variations.

In recent years, digital television systems have received a great deal of attention. In fact, legislation has been enacted requiring all commercial televisions sets to be based on a digitally transmitted signal. In other words, the digital television will displace the present analog television system. The use of the plasma operated screen would operate quite effectively in these television sets and was first recognized by the applicant prior to the filing of the initial patent application in 1998.

### SUMMARY OF THE INVENTION

It is, therefore, one of the primary objects of the present invention to provide a digital display system which operates with a plasma display screen and which can be operated with both static displays and continuous or dynamic displays. It is another object of the present invention to provide a display system of the type stated which is uniquely adapted for use in and which is capable of therefore constituting the basis of a digital television system.

It is a further object of the present invention to provide a digital display system of the type stated which is adapted for use in a wide variety of environmental conditions, such that it is capable of being used efficiently in relatively hot climates and also in relatively cold climates and which does not require sophisticated environmental control systems to be used therewith.

It is also an object of the present invention to provide a digital display system which is effective as a digital television and which does not suffer from the frailties of plasma operated screens in that the screen is sufficiently protected to be shipped, packaged and used much in the same manner as a conventional nondigital television set.

It is another salient object of the present invention to provide a method of generating a display transmitted from a remote source using a computer controlled plasma operated screen with either static or dynamic images thereon and which can be controlled from other remote sources.

It is still a further object of the present invention to provide a method of operating a television system using a computer controlled plasma display screen in which the pixels on the display screen are controlled through an X-Y computer control.

With the above and other objects in view, my invention resides in the novel features of form, construction, arrangement and combination of parts and components presently described and pointed out in the claims.

The present invention, in broad terms, relates to a digitally operated display system which employs a high resolution display screen capable of having photons controlled through X-Y coordinate axes from a computer. In particular, the display screen is operated by a computer station, preferably mounted within the housing of the display apparatus and which computer controls the energization of photons in the display and also controls the location of energization of such photons.

Also in a broad sense, the display screen not only is high resolution, it also has a wide angle of viewing with essentially little or no distortion at essentially any angle of view. In a preferred embodiment, the display screen is a plasma operated display screen. One of the preferred plasma screens is hereinafter described in more detail. However, any plasma screen may be used. Also, in another embodiment of the invention, any high resolution display screen having a wide viewing angle with a high degree of resolution can be used to the extent that it is digitally controlled. In this respect, and as indicated, the control over the plasma display screen would be derived from a computer. Moreover, by definition, the display screen and hence the entire display device is relatively thin in cross-section. Hence, the display screen would conform to the solution to a demand for a high resolution digitally operated relatively thin television display.

As indicated previously, the computer controls the basic operation of the display screen as well as any of a variety of systems which can be connected to the display system. The computer can therefore be relatively simple as long as the computer is only designed to control the operation of the display and perhaps selection of channels and the like. However, with respect to other functions which may be added to the digitally operated display system, the computer would have additional input/output functions arid hence the computer itself would be more complex from a standpoint of the operations to be performed.

The computer is operated in conjunction with some receiver associated with the plasma operated display screen for receiving signals from a remote source. Usually, the receiver is a wireless receiver so that signals are sent by wireless communication, e.g., broadcast signals and for that matter, signals bounced from satellite dished and the like. However, the present invention also contemplates the use of a receiver which is effectively hardwired to the remote source for directly delivering signals to the computer. To this extent, the signals which are transmitted from this remote source are hereinafter referred to as “electronic signals”. Moreover, and although the signals could be transmitted in analog format, and ultimately converted to digital format, the signals may preferably be transmitted in the digital format to the extent possible.

The display system may be relatively thin, as aforesaid, and contains those basic components necessary for the operation of the system. Obviously, one of the basic components is a display panel. One of the components operated in connection with the display panel would be a motherboard which constitutes one of the important components of the computer. This may be used in conjunction with a so-called “daughter board” which operates with a video translator. The display system would include an outer housing having an interior compartment for location of the operating components therein. An opening would be formed along one side for the display panel. Preferably, the display panel is protected by a transparent cover sheet. In addition, the computer would be operated by an internal power supply for controlling power both to the computer and to the display panel. Power regulators can also be used in conjunction with or form part of the power supply.

In order to receive certain broadcast signals, or otherwise even signals over a hardwire communication link, a modem would be employed. The exact size and type of the modem will vary depending upon the particular operation of the digital display system. Moreover, a memory section is associated with the motherboard. This memory section could be advantageously employed inasmuch as it is capable of digitally storing transmitted display signals which can be presented at a later time. Other storage capabilities are also provided by the storage section. Thus, computer routines enabling presentation of games and, for that matter, even interactive operations, can be stored in this main storage. The main storage preferably operates in conjunction with the motherboard although it could operate in conjunction with the daughterboard as well.

The display system would also include one or more speakers for audio presentation. These speakers would be connected to the video translator. In addition, the motherboard and even the storage therefor could potentially be connected to an audio receiver and amplifier which is frequently referred to as an “IDU”. In like manner, the motherboard and for that matter even the video transporter could be connected to a computer storage which is frequently referred to as an ATX. The purpose of the ATX is to receive and store audio visual broadcast material for presentation at a later time.

For purposes of environmental control, the housing of the display system would include one or more fans. These fans would be suitably operated from the main power source to the display system. Although other types of environmental control can be used, it has been found that the fans are sufficient for this purpose.

The motherboard could also be provided with a connection for use with the World Wide Web. In this way, the display system could be operated through the World Wide Web or otherwise, information over the World Wide Web in digital format may be transmitted to the display system. A digital convertor could also be included in the event that signals were transmitted in an analog format. In this way, either analog or digital signals may be transmitted to the display system.

Some of the components which could be coupled to or used with the display system include a remote sensor for controlling the operation of the display system. A recorder/player such as a VCR or laser disc player or other video source could be connected to the display system. In addition, a digital camera could actually be connected to the display system so that a digital photograph may be taken for actual display on the display system. Further, other computers could also be connected to the motherboard of this display system. In addition, interactive controllers can also be connected to the display system. For this purpose, a special control board useful with the interactive controllers would be mounted within the housing of the display system.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### DESCRIPTION OF THE DRAWINGS

FIG. 1 is a perspective view of the display system constructed in accordance with and embodying the present invention.

FIG. 2 is a front elevational view of one embodiment of the display system.

FIG. 3 is a somewhat schematic rear elevational view showing various components which could be incorporated in the display system of the invention.

FIG. 4 is a top plan view of the display system.

FIG. 5 is a bottom plan view of the display system.

FIG. 6 is a side elevational view of the display system, partially broken away and in section.

FIG. 7 is a somewhat schematic view showing auxiliary components which may be incorporated with or connected to the display system of the invention.

FIG. 8 is a schematic block diagram showing some of the major components of the digital display system of the present invention.

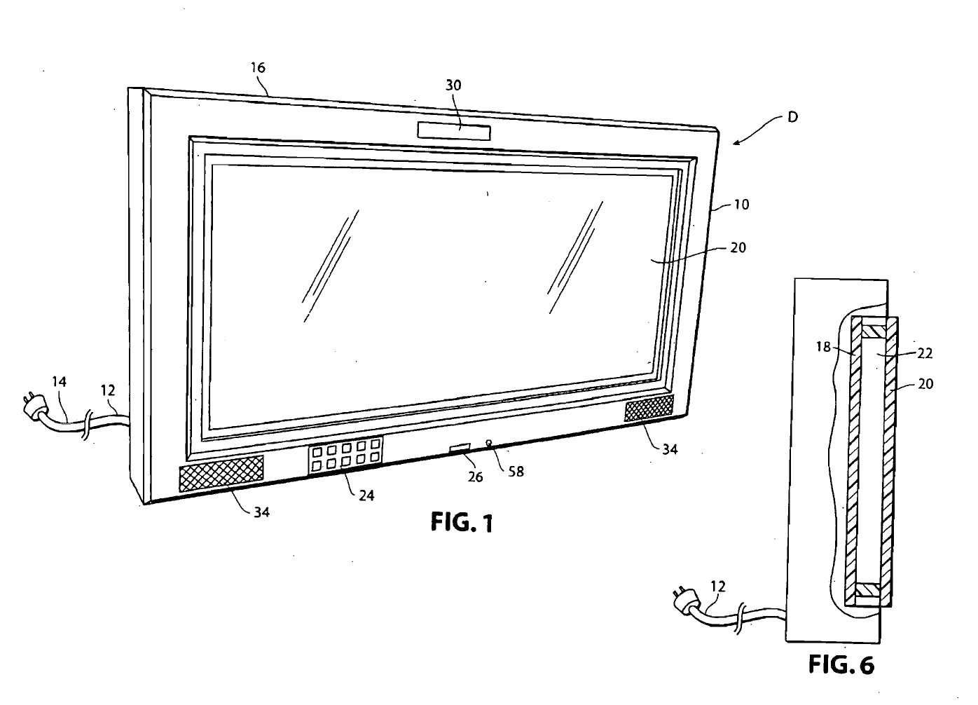

### DETAILED DESCRIPTION

Referring now in more detail and by reference characters to the drawings, which illustrate a preferred embodiment of the present invention, D designates a digital display system in accordance with the present invention. The display system of the illustrated and described embodiment employs a self-contained and dedicated computer along with a plasma operated display screen, all as hereinafter described in more detail.

The display system, sometimes referred to as a “display device” generally comprises an outer housing 10 which is relatively flat in cross-sectional thickness. This display system includes an electrical conductor 12 having a plug 14 at an outer end for connection to a suitable source of electrical power for operation.

The housing 10 is provided with a front panel 16 having an opening for allowing viewing of a display screen 18, as shown in FIG. 6. The display screen 18 is preferable covered by a relatively rigid and highly durable transparent protective sheet 20. In a preferred embodiment, the transparent sheet 20 may be formed of a durable relatively scratch-resistant plastic material. One such material which can be used and which retains its transparency for a long period of time is that polycarbonate offered under the name and mark “Lexan”. In actual construction, there exists a slight air gap 22 between the display screen 18 and the protective panel 20, as best seen in FIG. 6 of the drawings. Beyond this, the protective panel could be connected to the display screen as a unitary component. Otherwise, the panel could be merely fitted in the opening on the front of the housing 10.

The display screen 18 is preferably a plasma operated display screen, as aforesaid. However, other suitable high resolution display screens may be used, including such as an organic crystal display or for that matter an organic luminescent display. Further, an inorganic luminescent display could also potentially be used as the display screen in the apparatus of the invention.

The display screen is preferably made with a slightly thickened peripheral edge so as to obtain a generally uniform display thickness. One of the preferred types of display screens is that made by Toshiba. These display units are relatively thin and have a thickness in the order of about 3 mm. One of the preferred forms of display panel is made by Fujitsu and is identified as a “Full Color Plasma Display”. These displays effectively operate as high-definition direct-view television monitors.

These displays generally contain about 640 horizontal display pixels and about 480 vertical pixels along with about 1920 horizontal display cells and 480 vertical display cells. Moreover, they operate with gradations of red, green and blue and present a viewing angle of about 140°. Internally, the display is usually comprised of an IF controller, a data controller, a random access memory, and a driver controller. Nevertheless, since the plasma display is available in the art, it is therefore neither illustrated nor described in any further detail herein.

Also mounted on the housing 10 is a control panel 24 containing control switches for operation of the digital display system. These control switches may preferably be in the form of push button switches although other types of control switches could be used. The control switches would include for example, channel selection switches as well as off-on switches and volume controls. In addition, and for users who prefer a degree of sophistication, other controls for controlling the operation of the computer or for that matter the memory may also be made available. In addition, the control panel could be a plurality of individual control panels although only one has been shown for purposes of clarity.

A digital read-out device 26 may also be mounted on the front of the housing 10. This digital read-out device may preferably be in the form of a numerical read-out device presenting, for example, such information as channel selection, volume levels and the like. Obviously, if desired, a more sophisticated type of read-out device could be employed if desired.

The housing could also be provided with one or more pockets 28 having hinged cover doors for receiving one or more removable components. Thus, for example I a recording or playback member could be inserted in a pocket 30 located on the front of the housing 10. Located internally within the pocket would be provided connectors for automatically connecting to these one or more additional components. These connectors are not shown herein since they are conventional and clearly within the purview of one of ordinary skill in the art. Obviously, a plurality of input pockets could be provided for this purpose with each designed to receive a different type of compatible unit.

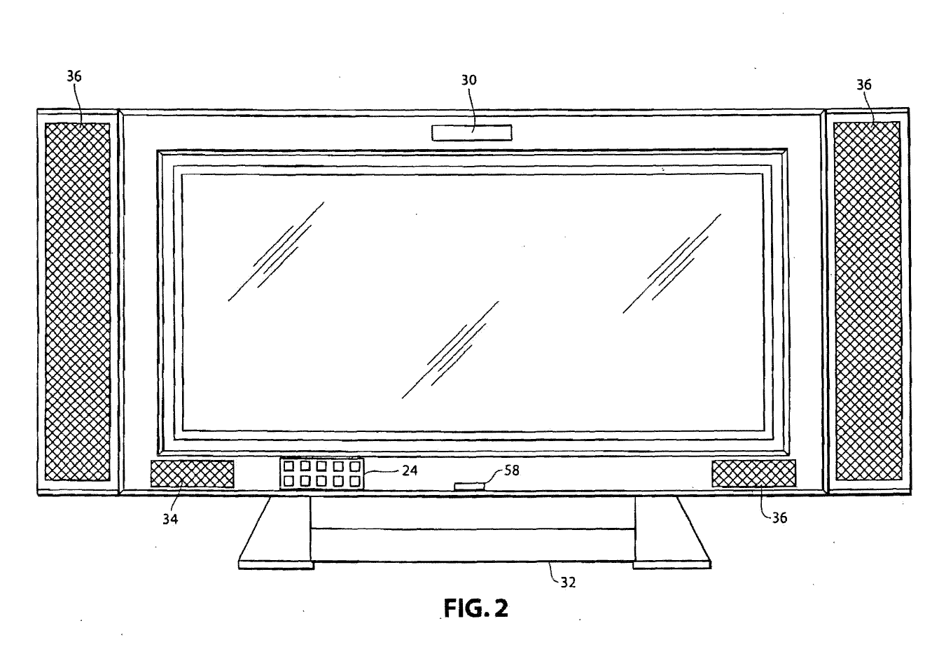

FIG. 2 illustrates a support stand 32 which may be optionally located on the underside of the housing 10. In addition, the housing 10 is also provided with a plurality of speakers 34 for purposes of presenting the audio information along with the video information. Other arrangements could also be used. Thus, in place or in addition to the speakers 34, it is also possible to use side mounted removable speakers 36. These speakers 36 could be connected to the audio amplifier (not shown) other than an ATX unit, forming part of the audio circuit of this system, either by hardwires or for that matter, they may be connected by means of non-wire communication to the audio amplifier. In this way, the auxiliary speakers 36 could be located elsewhere in a room of use for the desired sound effects.

One of the important factors of the present invention is the fact that the entire digital television is operated by a computer 38 which controls the operation of the plasma operated screen. Control is achieved by energization of pixels on the screen through a coordinate X-Y pattern. The screen is actually controlled through a program which may be embedded into a memory or otherwise, it can be introduced by means of a software program. A video translator circuit could also be employed as a dedicated computer and would replace the need for an actual computer per se. However, this dedicated video card would be provided with the proper input-output signals. Moreover, the video card could operate in conjunction with a separate memory, or it may contain its own memory, as well as a small processor, along with the embedded software therefore. Thus, the computer in any form, will operate both the display screen and provide for all of the necessary video recording and playback functions which use digital video signals.

In one of the important aspects of the invention, the computer is actually dedicated and self-contained. In other words, the computer can be a stand-alone device which is mounted within the housing. Moreover, it is dedicated only to the operations of the display device. Although the computer is preferably mounted directly within the housing, there are situations in which the computer could be physically located beyond the housing, that is, not directly mounted within the housing or for that matter, even physically secured to the housing. In these cases, the computer would be electrically connected to the other major operating components of the digital display system which are hereinafter described. Thus, as a simple example, the display system could be mounted on a wall and the computer could be mounted on the other side of that wall and electrically connected to the operating components of the digital display system. The computer itself may also be used for the operation of any peripheral components which may be connected to the display system.

For purposes of controlling and operating the computer, as well as the other electrical components forming part of the display system, there is provided a separate power supply 40 which is also mounted within the cabinet. The power supply could actually constitute multiple power supplies, if desired, for providing the necessary power to the various components, such as the display screen and the computer, as well as any of the other components forming part of the display system. For that matter, a second power supply 42 may also be provided.

The housing would also include an audio controller 44 which would control the audio portion of any broadcast or other display. The audio controller would include suitable audio amplifiers as well as gain controls and the like. Moreover, this audio controller 44 would be connected to the various speakers such as the speakers 34.

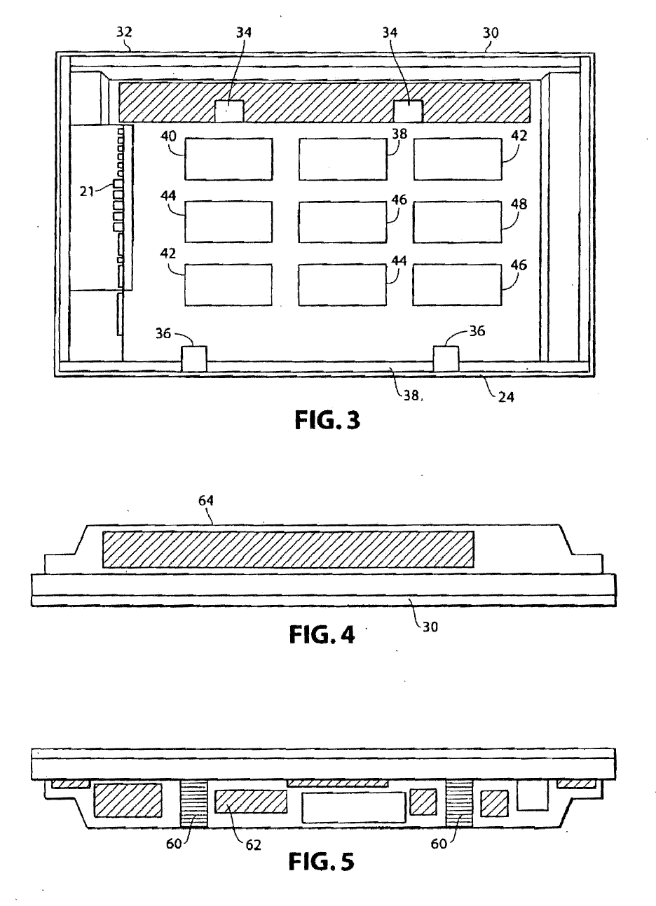

The rear portion of the housing, as shown in FIG. 3, could also be provided with one or more pockets 46 for retention of items. For example, a remote controller or the like can be located within this pocket for storage. Otherwise, the pocket could be sized for receiving external components operable with the display system. For example, a suitable recording or playback device could be inserted in this pocket on the rear portion of the apparatus. For this purpose, the pocket 46 would serve essentially the same purpose as the pocket 30 on the front portion of the housing 10.

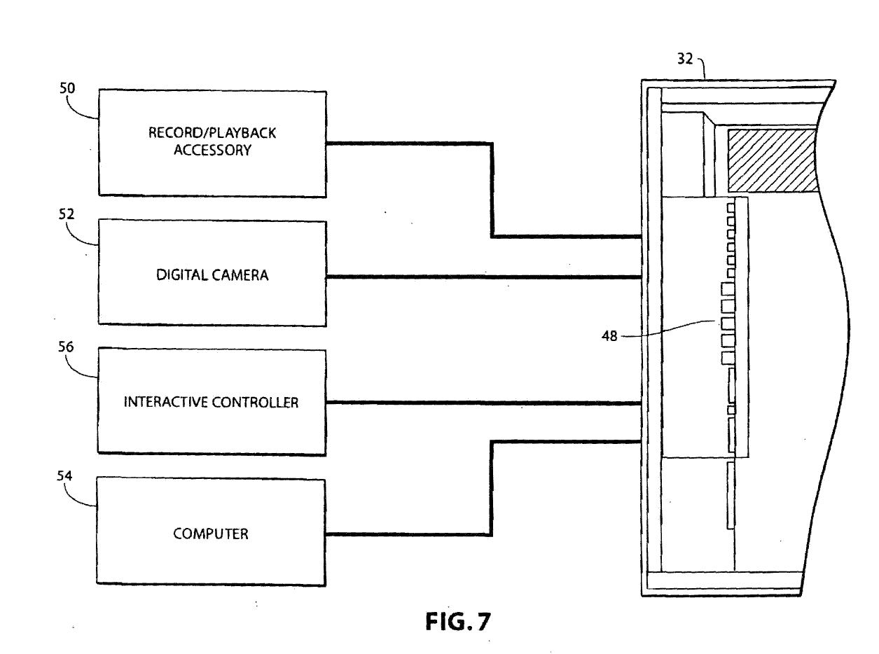

In addition, the housing may also be provided on a side portion thereof with a connector board 48. In this way, various auxiliary external components could be releasably connected to the display system by means of cables ending with jack connectors or the like. As a simple example, and as shown in FIG. 7, some of the devices which can be connected to the connector board 48 for operation with the display system include a recording-playback device 50 such as a video recorder, or a laser disc recorder or other video source.

It is also possible to display photographs taken through a video camera. For this purpose, the video camera 52 would be provided with a jack for connection to the display system. In addition, additional computers 54 could also be connected to the display system as shown in FIG. 7. For that matter, if the computer were not internally located within the housing as in the preferred construction, it could also be connected to these jacks for operation of the display system. Further, an interactive controller 56 could be connected to the housing through this connector board 48. In this way, interactive control can be employed with the broadcast display, depending upon the particular type of interactive capability with that broadcast.

The housing may also be provided with a remote control sensor 58 on the front surface thereof. This remote control sensor would be connected to the controller in the housing for both video and audio control in response to actuation of a remote control device. As indicated previously, it is important to insure that there is some type of environmental control in connection with the operation of the display system. For this purpose, it has been found that blower fans are usually effective for that. Thus, the apparatus may be provided at its lower face with inlet blower fans 60 for introducing cooling air into the interior of the housing 10. Moreover, the air which is introduced would be blown past the display panel for cooling of same. An additional air inlet 62 could also be provided on the bottom of the housing in the manner as shown in FIG. 5 for enabling a circulation of air even in the absence of the use of the blower fans 60. Finally, the housing would be provided on its upper end with an exhaust port 64, as shown in FIGS. 3 and 4 of the drawings. An additional exhaust port 66 could also be located at the rear panel. In actuality, the fans and the air inlet as well as the exhaust port could be provided at any suitable location on the housing in order to achieve optimum air flow through the interior of the housing.

Although the use of the blower fans and air exhausts for air convection cooling may be employed and has been found to be suitable in the invention, it is also possible to use other environmental control systems for that matter, even a heating system, if needed, for cold weather outdoor use or for that matter a type of rudimentary air conditioning system could be used. For this purpose, any suitable environmental control system can be employed.

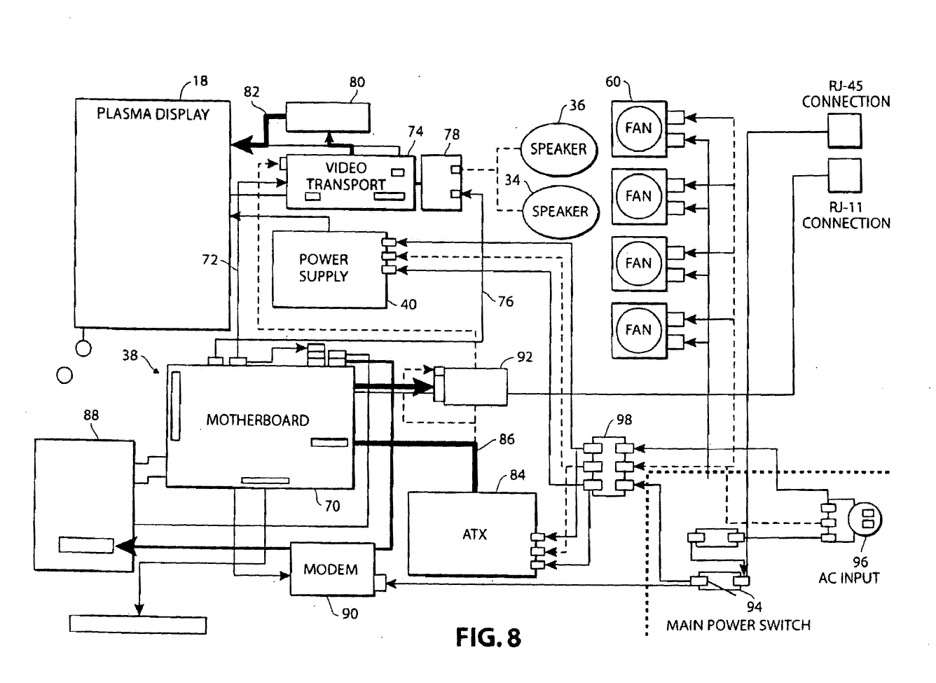

The major components forming part of the electrical arrangement of the display system are more fully illustrated in FIG. 8 of the drawings and comprises a motherboard 70 which constitutes one of the major components of the display system electronics and constitutes one of the major components of the computer 38. The motherboard effectively provides a video output, in the form of a VGA output signal 72, to a video translator 74. The motherboard 70 also provides an audio output 76 introduced into an audio control board 78. Thus, the motherboard essentially provides both the video and the audio outputs which are used in the display screen 18.

The audio board is connected to the video translator 74 in the manner as shown in FIG. 8. Moreover, the video translator provides an output to a daughterboard 80 which is, in turn, provided with the audio and video inputs combined at 82 into the display screen 18. The motherboard 70 is connected to and receives a major input from a computer storage and controller, commonly referred to as an ATX PC unit over an input line 86. The motherboard 70 also provides an output to a hard drive interface, commonly referred to as an IDEE and which, in turn, is connected to an RJ-11 connector.

The circuitry is further provided with a computer control board 88 having an input from the motherboard 70 and which also has outputs to the motherboard 70. One of those outputs is an ethernet output and the other is a USB-1 output. Further, the circuitry is provided with a modem 90 for receiving input signals carried over telephone communication links. The modem 90 is also connected to the motherboard 70 in the manner as shown and is further connected to the computer control board 88.

The overall major circuitry is further provided with a main power switch 94 which receives power from an AC input 96. The AC input and the main power switch are connected across a relay 98 and the latter of which provides electrical power to many of the components in the circuitry and particularly the power supply 40.

One of the important facets of the invention is the fact that this display system is effective for operating with more sophisticated modern recorder and playback devices and interactive devices. However, it is also capable of operating effectively with conventional earlier recording and playback devices such as, for example, a VCR. The display system also provides for both optical and sound signals.

Thus, there has been illustrated and described a unique and novel High Resolution and High Definition Computer Operated Digital Display System and which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

We claim:

1. A display system capable of generating a static or continuous display from electronic signals generated and transmitted from a remote source, said display system comprising:
a) an outer housing having an interior compartment and being operable at any of a plurality of fixed or movable locations;
b) a thin high resolution display panel on said housing and being observable to a group of viewers at wide angles;
c) a self-contained digital computer dedicated only to (1) the operation of the display system and any peripheral equipment used therewith and to (2) operation only as a computer and (3) a means to access other computers and a (4) means to access the World Wide Web to both receive information and to transmit information including displays over the World Wide Web;
d) said computer being located in operative relationship to said housing and receiving electrical signals from a remote source representative of the displays to be generated; and
e) said computer also controlling the energization of pixels on said display panel in an X-Y coordinate axis pattern in such manner to generate a display on said display panel and where the computer controls the generation of displays on said display panel, said computer further using the World Wide Web to receive information from and transmit information including displays to certain of such other computers and also enabling generation of selected portion of stored information and displays generated on said display panel to be sent over the World Wide Web, such that the stored information which is to be sent over the World Wide Web can be selected for transmission so that all or less than all of that stored information can be transmitted and also that such selected stored information may be transmitted to all of or less than all of such other computers, whereby there is a selectivity in the generation and transmission of information including displays over the World Wide Web and a selectivity in which locations will receive the selected portions of the stored information and receive other information including displays from the World Wide Web.

2. The display system of claim 1 further characterized in that said computer of said display system comprises a storage member enabling storage of signals transmitted for later retrieval and presentation and for storing instructions for computer related activities.

3. The display system of claim 2 further characterized in that said thin and flat high resolution display panel is a plasma operated display panel and is protected by a transparent cover sheet.

4. The display system of claim 1 further characterized in that said display system further comprises internal ventilating means in said housing to control heat generation by providing for heat dissipation and to reduce condensation which might form therein.

5. The display system of claim 1 further characterized in that said computer operates with a memory with size necessary to contain all of the data used to sequentially display a plurality of stored image displays.

6. The display system of claim 3 further characterized in that said system further comprises:
a) a protective transparent cover plate extending over said display panel; b) and spacer means holding said cover plate in spaced apart relationship from said display panel and provides an air gap therebetween.

7. A computer operated digital display system for generating a static or continuous image display on a display panel of that display system, said display system comprising:
a) an outer housing;
b) a display panel on said housing and being observable to a viewer;
c) a dedicated computer means located in proximity to said housing and dedicated primarily (1) to the operation of said display system and any peripheral components operable therewith and (2) to operation only as a computer and (3) a means to access other computers and (4) a means to access the World Wide Web, said computer means operating on the basis of a series of sequential programmed instructions at a predetermined time or on a real time basis, said computer means controlling the display presented on said display panel by controlling energization of individual pixels on the display screen through a coordinate X-Y axis pattern, said computer means further being capable of altering the manner in which a display is generated on the screen; and
d) said computer means further using the World Wide Web to receive information from and transmit information including displays to certain of such other computers and also enabling generation of selected portion of stored information and displays capable of being generated on said display panel to be sent over the World Wide Web, such that the stored information which is to be sent over the World Wide Web can be selected for transmission so that all or less than all of that stored information can be transmitted and also that such selected stored information may be transmitted to all of or less than all of such other computers, whereby there is a selectivity in the generation and transmission of information including displays over the World Wide Web and a selectivity in which locations will receive the selected portions of the stored information and receive other information including displays from the World Wide Web.

8. The display system of claim 7 further characterized in that said computer means is further provided with means providing enhancement of any display on the display panel and thereby enhancing the image displayed on said display panel.

9. The display system of claim 7 further characterized in that said computer means is also being capable of providing a high definition display.

10. The display system of claim 7 further characterized in that said display system comprises a storage member enabling storage of signals transmitted for later retrieval and presentation and for storing instructions for computer related activities.

11. A display system based on broadcast video and audio signals from a transmitting station for generating displays, said display system comprising:
a) an outer housing having an opening to receive a display panel;
b) an electronically operable computer controlled relatively flat display panel member viewable through said opening with wide angle viewing for displaying broadcast television images and other video images;
c) a self-contained and dedicated computer in said display system outer housing controlling operation of the flat display panel and for generating a display from electronic signals representative of the plurality of displays and which are broadcast from a remote source and to operation as a computer and to receive from and send information to the World Wide Web;
d) means associated with said computer for further using the World Wide Web to receive information from and transmit information including displays to certain of such other computers and also enabling generation of selected portions of stored information and displays generated on said display panel to be sent over the World Wide Web, such that the stored information which is to be sent over the World Wide Web can be selected for transmission so that all or less than all of that stored information can be transmitted and also that such selected stored information may be transmitted to all of or less than all of such other computers, whereby there is a selectivity in the generation and transmission of information including displays over the World Wide Web and a selectivity in which locations will receive the selected portions of the stored information and receive other information including displays from the World Wide Web; and
e) memory means in said display system outer housing and storing information delivered from a remote source and where such information is stored in digital signal format as digital signals and allowing the digital signals to be reconverted to visible images which are displayed at the display panel, and where different displays are storable in said memory means and displayed at time selected periods independently of external electronic signals from a remote source.

12. The display system of claim 11 further characterized in that said display system further comprises receiving means provided at said housing of said display system for receiving transmitted electronic signals representative of the displays from the remote source and transmit said signals to at least one of the computer or memory means.

13. The display system of claim 11 further characterized in that said display system is readily transportable and completely self-contained and positionable at a generally fixed location for operation at the fixed location

14. The display system of claim 11 further characterized in that said display panel is a computer controlled plasma operated display panel.

15. The display system of claim 14 further characterized in that said system comprises a protective cover member which is transparent and disposed over said display panel and being spaced apart therefrom.

16. The display system of claim 11 further characterized in that said system comprises internal ventilating means in said housing to control heat generation by providing for heat dissipation and to reduce condensation which might form therein.

17. The display system of claim 11 further characterized in that said computer is dedicated primarily to the operation of said display system and any peripheral components used therewith.
